(19) United States
(12) Patent Application Publication
(10) Pub. No.: US 2014/0293855 A1
(43) Pub. Date: Oct. 2, 2014

(54) WIRELESS COMMUNICATION SYSTEM AND WIRELESS ROUTER

(71) Applicants: Yasutaka Serizawa, Tokyo (JP); Kenichi Mizugaki, Tokyo (JP); Masayuki Miyazaki, Tokyo (JP)

(72) Inventors: Yasutaka Serizawa, Tokyo (JP); Kenichi Mizugaki, Tokyo (JP); Masayuki Miyazaki, Tokyo (JP)

(73) Assignee: Hitachi, Ltd.

(21) Appl. No.: 14/234,925

(22) PCT Filed: May 21, 2012
(86) PCT No.: PCT/JP2012/065827

§ 371 Date: Mar. 27, 2014

(30) Foreign Application Priority Data
Jul. 27, 2011 (JP) 2011-164017

(51) Int. Cl. H04W 52/02; H04W 84/18

(52) U.S. Cl. CPC H04W 52/0219; H04W 84/18
USPC 370/311

(57) ABSTRACT

In an ad-hoc wireless communication system, when there occurs a disparity in the remaining amounts of the batteries of wireless routers, it is impossible for each wireless router to change a communication route by itself. As proposed herein, in an invented multi-hop wireless network for communication via a plurality of routers, a wireless router operating intermittently changes its intermittent operation interval depending on its circumstances by its own judgment.

### TECHNICAL FIELD

The present invention relates to a wireless communication system and a wireless router and, in particular, to a wireless communication system and a wireless router in an ad-hoc network whose components become active intermittently.

### BACKGROUND ART

In industrial fields, there is a growing demand for wireless communication in terms of easiness of installation, low cost, easiness of operation, and expandability. In particular, a multi-hop communication is regarded as promising as a means for exceeding one-to-one communication distance limits attributed to power consumption and legal restrictions. To implement long-term operation of such a wireless communication system, it is necessary that terminals and routers that make up the system can operate at low power consumption. In this regard, the IEEE802.15.4e standard proposes a communication method in which a communication session starts upon receiving an activation notice from a receiving end. A receiving end (router) becomes active intermittently, broadcasts an activation notice toward its surroundings, and waits for a response. A transmitting end (terminal), if it has information to transmit, waits for an active notification from its surroundings and transmits information to a router that transmitted the active notification to the terminal. In this way, time during which routers are active is reduced and their power consumption is lowered.

Generally, in an ad-hoc network, depending on how routers are deployed, communication traffic may concentrate on some of the routers, which results in variance in the routers' battery consumptions. If the battery of a router on which communication traffic has concentrated runs out, it will have an impact on the entire system. An invention of patent literature 1 addresses this situation as follows: in a multi-hop wireless communication system in which a plurality of wireless terminals relay and transmit a transmission packet to one another based on routing information that is transmitted to and received from one another, each terminal changes an interval of transmitting routing information to its surrounding terminals depending on the remaining amount of its battery and the surrounding terminals judge the reliability of that terminal from the changed interval. That is, when transmitting routing information stored in a routing information table, each terminal determines an interval of transmitting the routing information to its surrounding terminals based on the remaining amount of its battery obtained from its battery remaining amount detecting unit and the setting in a transmission interval table. Based on that, the system changes routing, thereby smoothing the terminals' power consumptions.

In an invention of patent literature 2, a wireless terminal measures its power consumption after communicating for a given period with another wireless terminal which becomes active intermittently and changes its intermittent activation interval based on the measurement result. That is, based on the power consumptions of the terminals in the network, the intermittent activation cycle periods of the terminals are controlled. Thereby, terminals with less power consumption are preferentially selected as those through which a communication route is set up and thus the terminals' power consumptions are smoothed.

### CITATION LIST

### Patent Literature

Patent Literature 1: Japanese Unexamined Patent Application Publication No. 2005-295310

Patent Literature 2: Japanese Unexamined Patent Application Publication No. 2010-28168

### SUMMARY OF INVENTION

### Technical Problem

As noted previously, in an ad-hoc network, generally, depending on how routers are deployed, communication traffic may concentrate on some of the routers, which results in variance in the routers' battery consumptions.

The invention of patent literature 1 seeks to smooth the battery power consumptions of the terminals that make up the multi-hop wireless communication system in such a way that each terminal changes the interval of transmitting routing information depending on the remaining amount of its battery. However, a plurality of terminals transmit routing information to one another in a non-intermittent mode; that is, they are always active. Consequently, there is a difficulty in reducing the power consumptions of all terminals across the multi-hop wireless communication system and attempting long-term operation of the system.

In the invention of patent literature 2, each terminal needs to communicate with another terminal for a certain period in order to make an analysis for acquiring routing information. Therefore, the intermittent activation interval and communication environment of a communication partner and which terminal is selected as the one with which to communicate, among others, have an influence on power consumption measurement and there is a possibility of setting up an inefficient route.

Meanwhile, a large difference in the easiness to replace the batteries of routers may arise depending on the positions where the routers are installed. In this situation, it can be considered that maintenance becomes easier by concentrating communication traffic on a router whose battery is easy to replace, rather than evenly consuming the batteries of all routers configured in the system. Moreover, if there is a router having a method of power feeding by itself such as a solar battery panel or power supply, it can be considered that a total of battery consumption across the system is suppressed by concentrating communication traffic on such a router.

However, in the heretofore known techniques regarding an ad-hoc network based on intermittent activation, a way of smoothing a disparity in the remaining amounts of the batteries of the routers was not adaptable to the routers' communication environments such as a characteristic specific to a router and installation condition. For example, if there occurred a disparity in the remaining amounts of the batteries of wireless routers, each wireless router were unable to change a communication route by itself. Therefore, even if there was a router having a larger remaining amount of battery, a router whose battery is easy to replace, or a router having means for power feeding by itself such as a solar battery panel, it was impossible to exploit such a router preferentially.

An object of the present invention is to solve the problems of the foregoing heretofore known techniques and provide a multi-hop wireless communication system and a wireless router in which a wireless router changes a communication route by itself and long-term operation of the system is enabled.

### Solution to Problem

An example of a typical implementation of the present invention is as follows: a wireless communication system for multi-hop communication through an ad-hoc network, the wireless communication system comprising a plurality of wireless routers and at least one terminal, characterized in that: each wireless router includes a battery, a detection means for detecting the battery state, a table providing information on its own intermittent operation interval of the wireless router, and a control device that controls communication; the intermittent operation interval in the table is set so that, depending on communication environment of the wireless router, including the station's battery state, the intermittent operation interval should be set shorter for a wireless router having a better communication environment; and each wireless router sets or changes its intermittent operation interval, based on its communication environment and information in the table, and forwards communication information from the terminal during the intermittent operation.

### Advantageous Effects of Invention

According to the present invention, long-term operation of the system becomes feasible.

### BRIEF DESCRIPTION OF DRAWINGS

FIG. 1 is a diagram depicting a configuration example of a multi-hop wireless communication system to which the present invention is applied.

FIG. 2 is a diagram depicting a configuration example of a terminal in a first embodiment of the present invention.

FIG. 3 is a diagram depicting a configuration example of a router in the first embodiment.

FIG. 4 is a diagram representing an example of an intermittent operation interval table in the first embodiment.

FIG. 5A is a flowchart illustrating operation of a router 10 in the first embodiment.

FIG. 5B is a diagram illustrating a message flow in the wireless communication system of FIG. 1 according to the first embodiment.

FIG. 6 is a diagram to explain changing the intermittent operation interval of a router in the first embodiment.

FIG. 7 is a diagram to explain a procedure for selecting a router to which communication information is to be transmitted, assuming a case where a plurality of routers exist in the surroundings of a terminal.

FIG. 8 is a diagram depicting a configuration example of a router in a second embodiment of the present invention.

FIG. 9 is a diagram representing an example of an intermittent operation interval table in the second embodiment.

FIG. 10 is a diagram depicting a configuration example of a router in a third embodiment of the present invention.

FIG. 11 is a diagram representing an example of an intermittent operation interval table in the third embodiment.

FIG. 12 is a diagram depicting a configuration example of a terminal with the function of a router according to a fourth embodiment of the present invention.

### DESCRIPTION OF EMBODIMENTS

According to a typical embodiment of the present invention, in a multi-hop wireless network for communication via a plurality of routers, each wireless router operating intermittently changes its intermittent operation interval depending on its communication environment including its battery state by its own judgment.

Embodiments which will be described hereinafter are assumed to be implemented in a wireless communication system for ad-hoc communication in an asynchronous and intermittent activation manner, based on the IEEE802.15.4e standard which is anticipated to be standardized as a wireless connection scheme for use in an ad-hoc network.

In an ad-hoc network, a purpose-built base station is not used and making a terminal-to-terminal connection among many terminals is performed using a relay function that each terminal device itself has and by a “multi-hop communication” technique without intervention of a base station. That is, in the multi-hop communication, the network configures a group of terminals that are interconnected temporarily and the communication area is expanded, while transmissions are relayed through other terminals even without a base station. Thus, the multi-hop communication is suitable for a wireless system that covers a wide range with low power consumption.

According to a typical embodiment of the present invention, in a wireless communication system using a multi-hop communication scheme, including a plurality of routers operating intermittently and at least one terminal that performs data transmission upon receiving an activation notice signal from any router, each router that operates intermittently (becomes active intermittently) changes an interval of intermittent operation depending on its communication environment condition by its own judgment. The interval of intermittent operation should be set shorter for a wireless router having a better communication environment. Thereby, each wireless router is able to change a communication route by itself and long-term operation of the system becomes feasible. That is, the following are made possible: battery consumptions depending on communication environment such as a characteristic specific to a router and installation condition; and long-term operation of the system. Besides, because each router can judge by itself if an activation interval has changed; it is possible to make a route selection to allow for lengthening the system lifetime without being influenced by the intermittent activation interval and communication environment of a communication partner and which terminal is selected as the one with which to communicate, among others.

In the following, embodiments of the present invention will be described with the aid of the drawings. In the following description, it is assumed that a router forwards communication information transmitted by a terminal to an access point (AP).

### First Embodiment

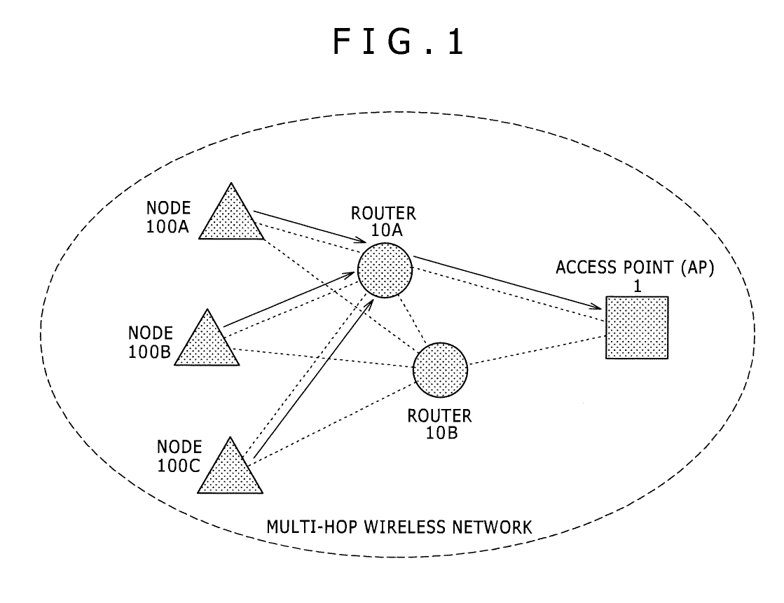

A first embodiment of the present invention with regard to a multi-hop wireless communication system in ad-hoc network is described with reference to FIGS. 1 through 7.

FIG. 1 depicts a configuration example of a multi-hop wireless communication system to which the present invention is applied.

The multi-hop wireless communication system of the present invention includes a plurality of wireless routers 10 (A, B) operating intermittently, a plurality of terminals 100 (A, B, C) that perform data transmission upon receiving an activation notice signal from any router, and an access point 1 (AP) that is a destination of communication information transmitted by each terminal. The terminals 100 (A, B, C) have a function of acquiring new communication information specific to the terminal by a sensor or the like and are capable of transmitting the communication information. The routers 10 (A, B) become active intermittently and have a function capable of changing their activation cycle period and a function of transmitting and receiving communication information. For the sake of simplifying description, the system presented here configures three terminals, two routers, and one access point (AP) (1). It goes without saying that there is no limitation in the number of these respective types of devices making up the wireless communication system. An example of FIG. 1 presents a network configuration in which the plural terminals 100 (A, B, C) get access to the access point (AP) 1 via one router 10 (A) by multi-hop communication.

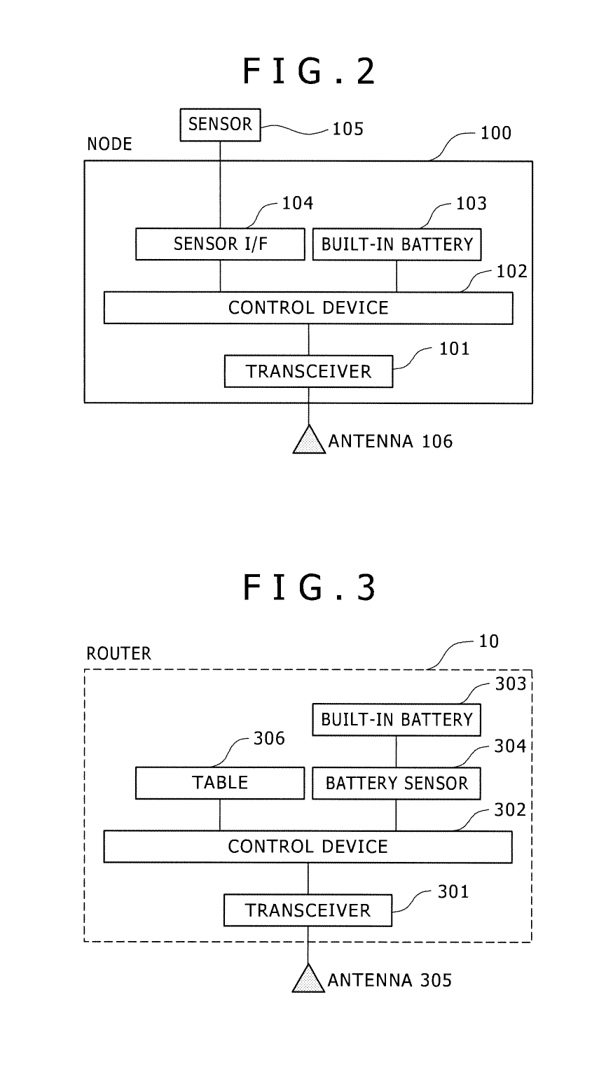

FIG. 2 depicts an example of a configuration of a terminal 100. The terminal 100 configures a sensor 105 and a sensor interface (I/F) 104 to which the sensor is connected, a built-in battery 103, a control device 102 that controls the built-in battery 103 and the sensor 105 and controls communication of the terminal 100, and a transceiver 101 for transmitting communication information from an antenna 106 under command of the control device 102 and receiving communication information. In other words, the terminal 100 is configured with a computer and includes a ROM (omitted from depiction) having stored therein a control program that controls the control device (microprocessor) 102 and causes it to perform various control operations for multi-hop wireless communication and a RAM (omitted from depiction) storing therein various kinds of information such as sensor acquired information, which are accessed by the control device 102. The sensor 105 acquires new communication information, e.g., gas concentration, potential, liquid level, temperature, and the open/closed state of a switch. The present invention can also be applied to a terminal without having a sensor, in which the terminal itself serves as a position sensor by transmitting a signal periodically. Besides, the present invention can also be applied to a terminal that is supplied with power from a power supply instead of the built-in battery.

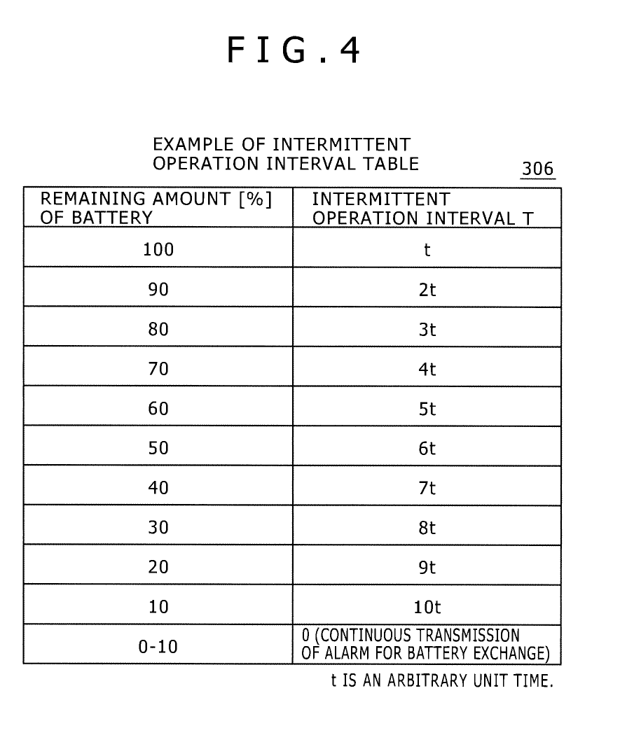

FIG. 3 depicts a configuration example of a router 10 in the first embodiment. The router 10 configures a built-in battery 303, a battery sensor 304 that measures the remaining amount of the built-in battery 303 and inputs it to the control device 302, an intermittent operation interval table 306 held in a RAM, a control device 302 that controls communication of the router 10 and controls the intermittent operation interval, and a transceiver 301 for transmitting communication information from an antenna 305 under command of the control device 302 and receiving communication information.

The control device of each router has a function of by itself creating ad-hoc network routing to route a transmission via any other router serially to the access point (AP) during inactivity according to a routing protocol for multi-hop wireless communication. This routing information is retained in a routing table (omitted from depiction) and updated periodically. As the routing protocol, an optimal scheme which may be, e.g., proactive or reactive may be adopted according to the scale and density of routers configured in the multi-hop wireless communication system and a high or low degree of mobility of the routers, among others. In other words, a router 10 is configured with a computer and includes a ROM having stored therein a control program that controls the control device (microprocessor) 302 and causes it to perform various control operations for multi-hop wireless communication and a RAM storing therein various kinds of information in table form or the like, such as intermittent operation interval information and routing information, which are accessed by the control device 302.

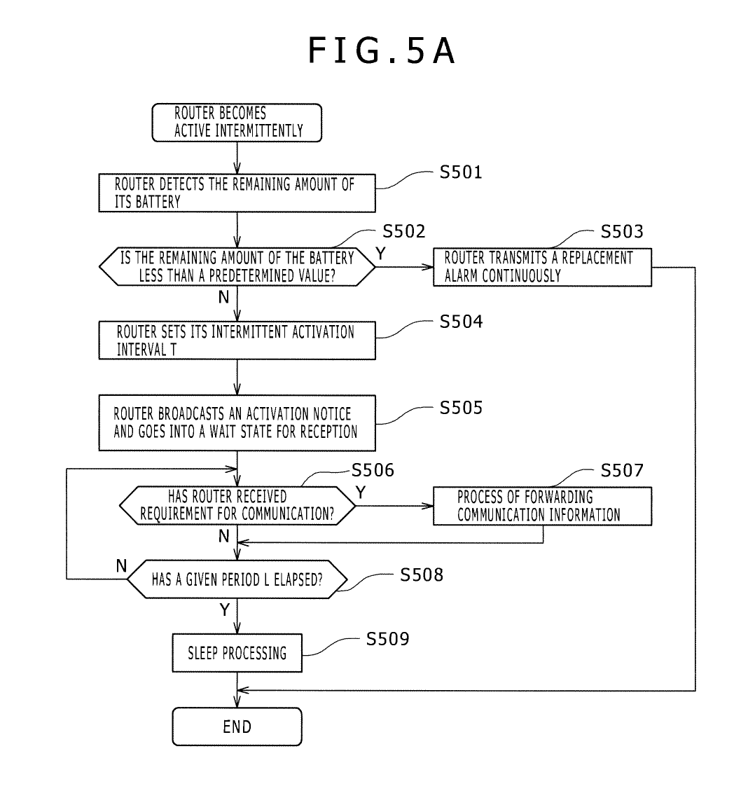

FIG. 4 represents an example of the intermittent operation interval table 306. This intermittent operation interval table 306 provides information on its own intermittent operation interval (in other words, sleep state interval) of the router 10 that retains this table. That is, this table provides relation of the intermittent operation interval T to the remaining amount (%) of the built-in battery 303 of the router 10 itself. When the remaining amount of the battery is 100(%), condition T=t occurs, where t is an arbitrary unit time. In this example, as the remaining amount of the battery decreases to 90(%), 80(%), and so on, the intermittent operation interval T becomes gradually longer, as 2t, 3t, and so on. When the remaining amount of the battery becomes less than 10(%), condition t=0 occurs and the router is placed in a mode in which it transmits a replacement alarm continuously. An absolute value of t is set, as appropriate, depending on the communication environment or the like of each router 10.

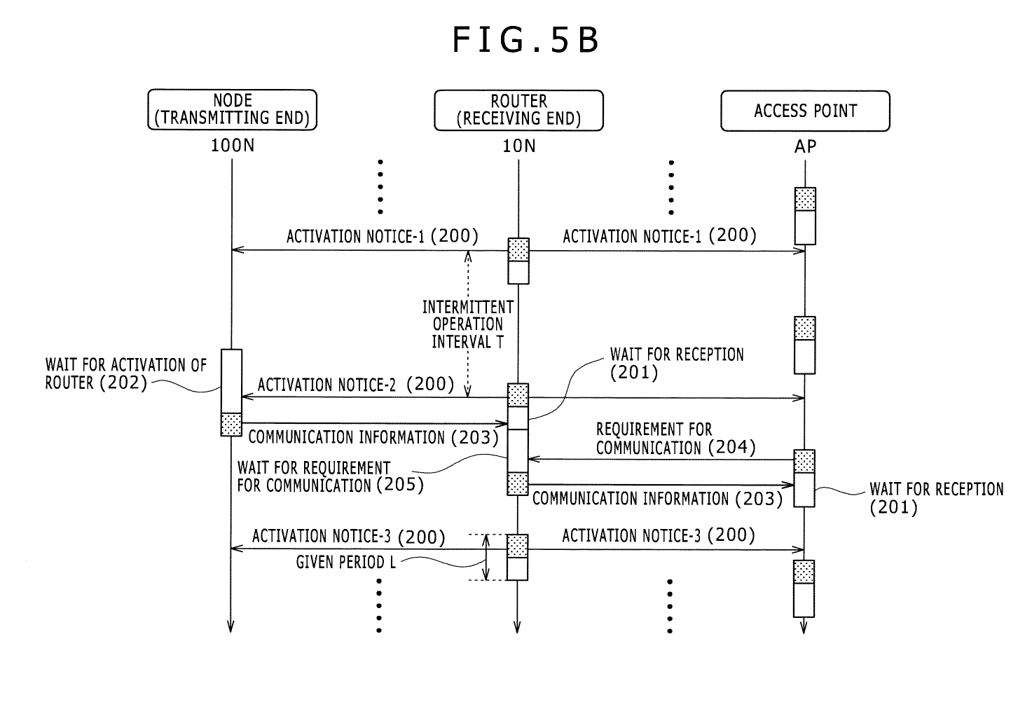

FIG. 5A is a flowchart illustrating operation of a router 10 in the first embodiment. The router 10 cycles between active and sleep states in an intermittent manner. When the router 10 is put in a sleep state, a timer provided in the control device 302 measures time until reactivation. This time is the intermittent operation interval T. During a sleep state, the router 10 shuts off the power supply to the transceiver 301, the control device 302 itself operates at low power, and only the timer and related components required for reactivation are operating.

When a value measured by the timer becomes equal to the intermittent operation interval T, i.e., the time to go into reactivation, the router 10 becomes active (becomes active intermittently). Once having become active intermittently, the router 10 first turns the battery sensor 304 on and detects the remaining amount of its battery (S501). It determines whether or not the remaining amount of the battery is less than a predetermined value (Tlim) (S502). That is, it is determined whether or not the remaining amount of the battery is less than (Tlim) based on the value in the table 306 retained in the RAM. Here, according to the example of FIG. 4, if the remaining amount of the battery is less than 10(%), by transmitting a battery replacement alarm continuously (S503), the router 10 alerts the user that its built-in battery 303 needs to be replaced and then terminates this process.

Otherwise, if the remaining amount of the battery is more than or equal to 10(%), the router sets its intermittent operation interval T depending on the remaining amount of the battery (S504). Then, the router broadcasts an activation notice, goes into a wait state for reception, and awaits reception (S505). When the router receives a requirement for communication in a reception ready state (S506), it performs a process of forwarding communication information (S507) and, upon completing the process, becomes awaiting reception. When a given period of time (an active period of the router 10) L has elapsed (S508), the router performs sleep processing (509) and returns to the sleep state.

The active period L of the router 10 is set quite shorter than the intermittent operation interval T, i.e., the sleep state period (L<T). By way of example, in a state when the remaining amount of the battery is 100(%), the given active period L is set at one tenth or below of the sleep state period T. Of course, if it takes time to complete a process of forwarding communication information, L/T may become larger, e.g., 0.3 to 0.5. Overall, L should shrink considerably than T (L<T). By reducing the active period of each router depending on the remaining amount of the battery, it is possible to reduce a total of power consumption across the wireless communication system, while maintaining required communication environments. That is, each router operates intermittently and the intermittent operation interval should be set shorter for a wireless router having a better communication environment. Thereby, it is possible to reduce a total of power consumption across the multi-hop wireless communication system, while maintaining required communication environments.

FIG. 5B illustrates a message flow in the multi-hop wireless communication system of the present embodiment based on a communication protocol of the IEEE802.15.4e standard. A receiving-end router 10N operates intermittently, becoming active at each end of the intermittent operation interval T. Upon becoming active, the router sets its intermittent operation interval T. Then, it broadcasts a first activation notice-1 (200) toward its surroundings and then goes into a wait state for reception (201). Upon the elapse of a given active period L, the router goes into the sleep state.

A transmitting-end terminal 100N, when communication information is generated in it, waits for activation of a router (202) in order to receive an activation notice (200) from each router 10. From the router 10N, once having received an activation notice, a second activation notice-2 (200) in this example, the terminal transmits communication information (203) to the router 10N that transmitted the second activation notice-2 (200) to the terminal. In this way, in the IEEE802.15.4e communication protocol, a communication session starts upon receiving an activation notice from a receiving end. When the router 10N receives the communication information (203) during a wait for reception (201), the router goes into a wait for activation of a router (202) and awaits a requirement for communication (204) from an access point AP1 or an activation notice (200) from a next router.

The access point AP1 broadcasts a requirement for communication (204) to each relation station 10 and each terminal 100 at an arbitrary interval and goes into a wait for reception (201).

When the router 10N or the terminal 100N receives the requirement for communication (204) from the access point AP1, it transmits communication information (203) to the access point AP1 and then goes into a wait for a requirement for communication (205).

If the router 10N has not received communication information (203) for a given period (active period L) or longer during the wait for reception or the wait for a requirement for communication (205), it goes into the sleep state. After the intermittent operation interval T that has been set, it becomes active again and repeats the foregoing operations.

In a case where the terminal 100N has determined that it needs to transmit communication information, e.g., when its sensor connected to it has detected an abnormal value or when a given period has elapsed after the previous transmission of communication information, the terminal waits for activation of a relation station (202). In other words, the activation interval of the terminal 100N is not defined. In this state, once the terminal 100N has received an activation notice (200) or a requirement for communication (204), it transmits communication information (203) to the router or the AP that is the notification or request transmitter. At this time, before transmitting communication information (203), the terminal 100N may transmit an advance notice of transmission of communication information to the notification or request transmitter (router or AP) and establish a link; after that, the terminal may transmit the communication information (203). Even in a case where this method is used, the present invention can be applied.

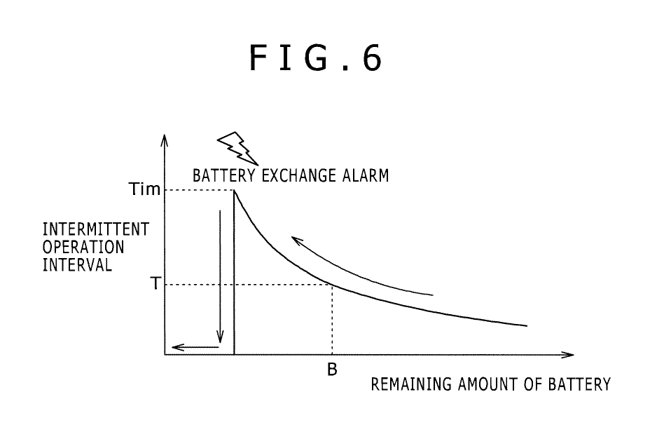

FIG. 6 is a graph representing an example of a correlation between the remaining amount of the battery B and the intermittent operation interval T of a router 10. This graph corresponds to data in the intermittent operation interval table 306 of FIG. 4. As described previously, the control device 302 of each router 10 has information representing a correlation between the remaining amount of the battery B and the intermittent operation interval T as in FIG. 6 as the table provided beforehand and determines a value of the intermittent operation interval T depending on the detected value of the remaining amount of the battery of the router. The control device sets the intermittent operation interval T shorter when the remaining amount of the battery is larger and sets T longer when the remaining amount of the battery is smaller.

Thereby, for a router for which the remaining amount of the battery is larger, the number of times it operates per unit time increases and it is more probable for the router to relay communication information 203 from a terminal 100. On the other hand, for a router for which the remaining amount of the battery is smaller, its intermittent operation interval T (sleep state) becomes longer and it is less probable for the router to relay communication information. That is, there is a higher probability that a router for which the remaining amount of the battery is larger relays communication information even without an ad-hoc route setup in advance. Consequently, a router for which the remaining amount of the battery is larger forwards communication information more often and it is possible to smooth a disparity in the remaining amounts of the batteries of the routers within the multi-hop wireless system. Thus, long-term operation of the system is enabled.

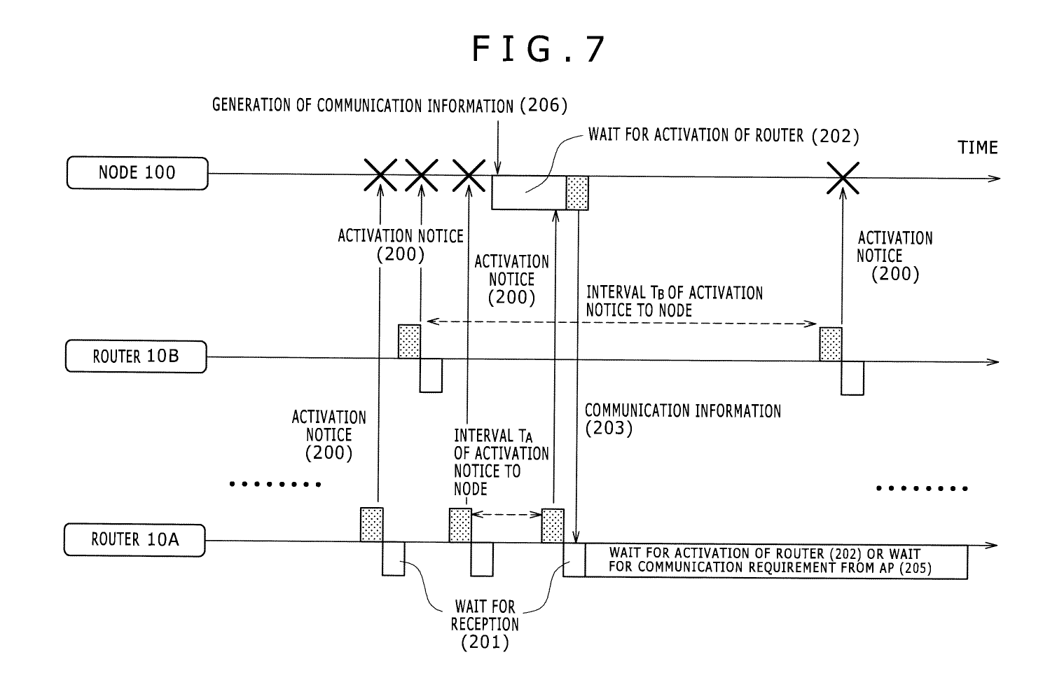

Assuming a case where a plurality of routers exist in the surroundings of a terminal, FIG. 7 is a diagram to explain a procedure for selecting a router to which communication information is next to be transmitted. In an example of FIG. 7, the intermittent operation interval T_{B} of a router 10B is set longer than the intermittent operation interval T_{A} of a router 10A. How to determine there intermittent operation intervals T will be detailed later. Because the router 10A having the shorter intermittent operation interval T transmits an activation notice 200 a more number of times within unit time, it is more probable for the terminal 100 to receive an activation notice 200 from the router 10A during a wait for activation of a router 202. Thus, it is more probable for the router 10A to relay communication information 203 from the terminal 100 than the router 10B. Once having received communication information 203 from the terminal 100, the router 10A goes into a wait for activation of a router (202) or a wait for a requirement for communication (205) and forwards the communication information 203 in the same procedure as described previously. In this regard, in forwarding information between routers, based on routing information that each router has, a router that is going to forward information responds to only activation information from a router existing in a route approaching the AP that is the destination of communication information. This prevents forwarding communication information in a direction opposite to the AP.

According to the present embodiment, the following are made possible: battery consumptions depending on communication environment specific to a router; and long-term operation of the system. Besides, because a router can judge by itself if an activation interval has changed; it is possible to make a route selection to allow for lengthening the system lifetime without being influenced by the intermittent activation interval and communication environment of a communication partner and which terminal is selected as the one with which to communicate, among others.

### Second Embodiment

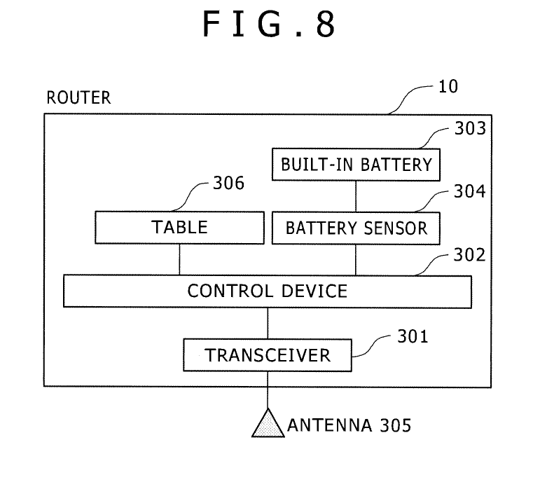

Next, a second embodiment of the present invention is described. FIG. 8 depicts a configuration example of a router 10 in the second embodiment. The router 10 configures a built-in battery 303, a battery sensor (omitted from depiction), a control device 302 that controls communication of the router 10 and controls the intermittent operation interval, an intermittent operation interval table 306, and a transceiver 301 for transmitting communication information from an antenna 305 under command of the control device 302 and receiving communication information. As for components other than the intermittent operation interval table 306, refer to the foregoing description of the first embodiment.

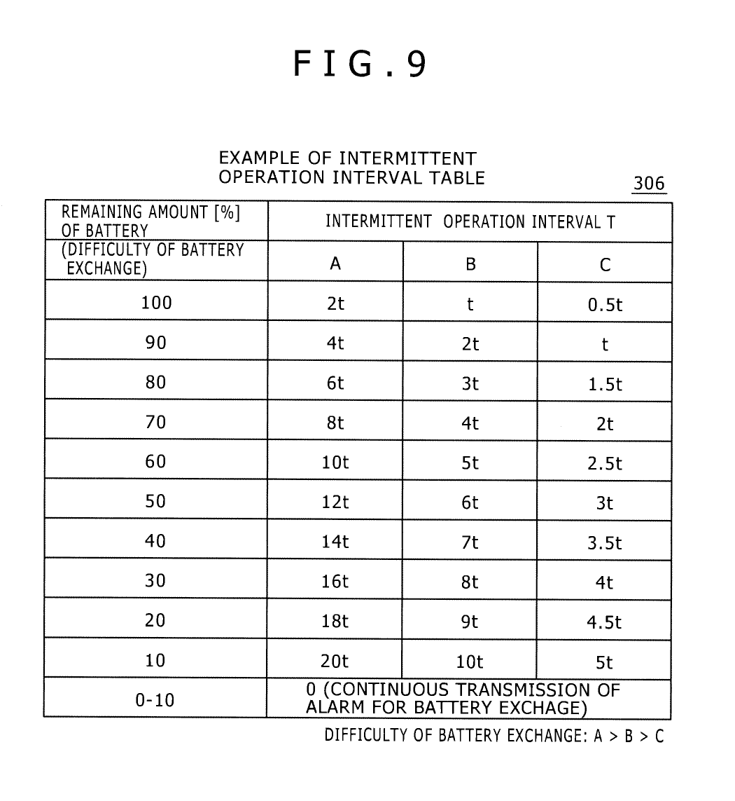

FIG. 9 is a diagram representing an example of the intermittent operation interval table 306 in the second embodiment.

In the present embodiment, intermittent operation intervals T are quantized per router in consideration of difficulty D of battery replacement from, inter alia, environments where routers are installed. In an example of FIG. 8, the difficulty D of battery replacement is classified into three degrees A, B, and C>B>C). According to each of these degrees, values of the intermittent operation interval T of a router are set depending on the remaining amount of the battery detected by the battery sensor of the router. The values of the intermittent operation interval T of a router with a lower degree of difficulty are set shorter; for example, depending on the remaining amount of the battery, interval values t, 2t, etc. are set for difficulty degree B, whereas interval values 2t, 4t, etc. are set correspondingly for difficulty degree A. The values in the intermittent operation interval table 306 are input to the control device 302 and the control device 302 determines an intermittent operation interval T according to difficulty degree. In particular, for a router installed in an environment where the battery is difficult to replace, the intermittent operation interval T is set longer; for a router installed in an environment where the battery is easy to replace, the intermittent operation interval T is set shorter. In this way, control is implemented so that battery consumption will intensify at a router whose battery is easy to replace and the maintenance cost for battery replacement is suppressed.

Accordingly, the following are made possible: battery consumptions depending on communication environment such as a characteristic specific to a router and installation condition; and long-term operation of the system. Besides, because a router can judge by itself if an activation interval has changed; it is possible to make a route selection to allow for lengthening the system lifetime without being influenced by the intermittent activation interval and communication environment of a communication partner and which terminal is selected as the one with which to communicate, among others.

### Third Embodiment

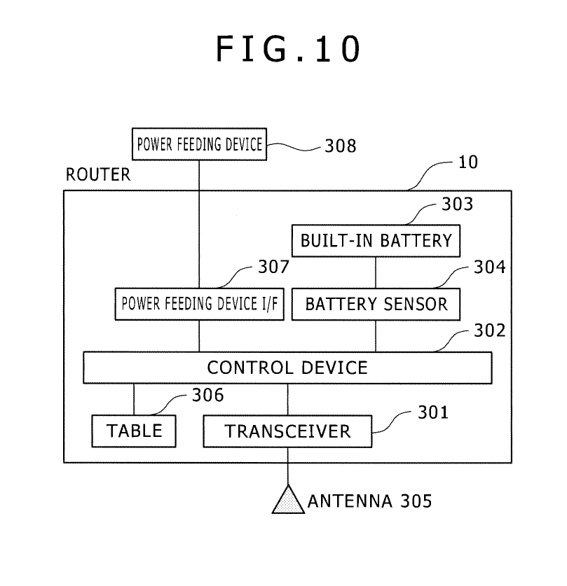

Next, a third embodiment of the present invention is described. FIG. 10 depicts a configuration example of a router 10 in the third embodiment. The router 10 configures a built-in battery 303, a battery sensor (omitted from depiction), a control device 302 that controls communication of the router 10 and controls the intermittent operation interval, an intermittent operation interval table 306, a transceiver 301 for transmitting communication information from an antenna 305 under command of the control device 302 and receiving communication information, and a power feeding device I/F 307 which provides a connection to a power feeding device 306. As for components other than the intermittent operation interval table 306, refer to the foregoing description of the first embodiment.

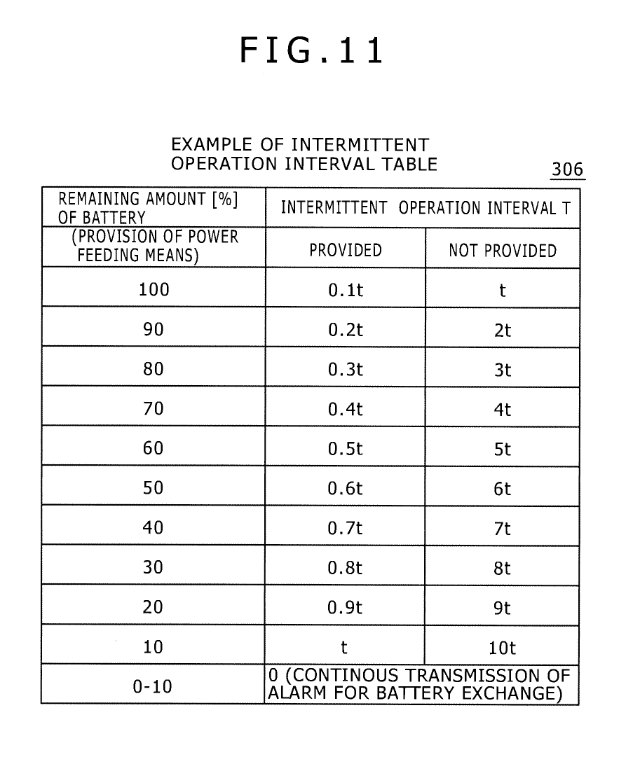

FIG. 11 is a diagram representing an example of the intermittent operation interval table in the third embodiment. In the present embodiment, intermittent operation intervals T are quantized per router in consideration of whether or not a router is provided with a power feeding means. In an example of FIG. 11, for a router provided with the power feeding means, depending on the remaining amount of the battery, values of its intermittent operation interval T are set, such as 0.1t, 0.2t, etc., at one tenth of the corresponding interval values of a router not provided with the power feeding means. A router 10 judges whether or not it is provided with the power feeding means by operator input or by recognizing a device connected to it. The power feeding means herein is a solar power system or power supply from a power source. According to the relevant information, the control device 302 sets the intermittent operation interval T shorter for a router provided with the power feeding means and sets the intermittent operation interval T longer for a router not provided with the power feeding means.

Thereby, a router provided with the power feeding means as a communication environment becomes active frequently and the number of times other routers transmit and receive information is reduced and their power consumptions are suppressed. Because a router provided with the power feeding means is able to charge its battery with the power feeding means, a total of battery consumption across the system is reduced and the system lifetime can be lengthened.

### Fourth Embodiment

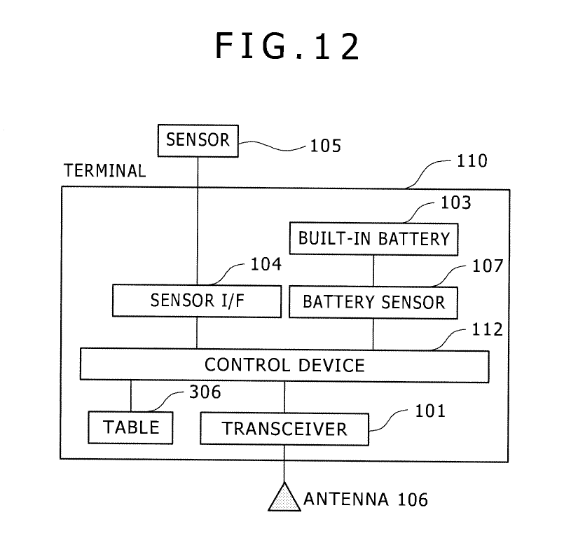

Next, a fourth embodiment of the present invention is described. FIG. 12 depicts a terminal configuration diagram in a case where a terminal 110 with the function of a router (a terminal also serving as a router) is used as the fourth embodiment. This terminal also serving as a router and a plurality of other wireless router or terminals constitute a wireless communication system for multi-hop communication through an ad-hoc network.

The terminal also serving as a router 110 configures a sensor interface (I/F) 104 for connecting a sensor 105 that measures sensed data to the terminal, a built-in battery 103 and a battery sensor 107 that measures the remaining amount of the battery B, a control device 112 that controls the sensor 105 and the battery sensor 107 and controls communication, and a transceiver 111 for transmitting communication information under command of the control device 112 and receiving communication information.

In the present embodiment, the terminal also serving as a router 110 becomes active intermittently to forward communication information from another terminal as the router, in addition to transmitting communication information by it. Details of the terminal and router functions of the terminal also serving as a router 110 are the same as described in the first through third embodiments.

Even in the present embodiment, the intermittent operation interval should be set shorter for a terminal also serving as a router having a better communication environment. Thereby, the following are made possible: battery consumptions depending on communication environment such as a characteristic specific to a terminal also serving as a router and installation condition; and long-term operation of the system. Besides, because a terminal also serving as a router can judge by itself if an activation interval has changed; it is possible to make a route selection to allow for lengthening the system lifetime without being influenced by the intermittent activation interval and communication environment of a communication partner and which terminal also serving as a router (or which router) is selected as the one with which to communicate, among others.

### Fifth Embodiment

Next, a fifth embodiment of the present invention is described. The multi-hop communication system through an ad-hoc network of the present invention can widely be applied to wireless systems covering a wide range with low power (low power consumption), such as AMI (Advanced Metering Infrastructure) and in-house wireless networks. The invented system is suitable for, for example, installing a terminal with a sensor or a terminal also serving as a router in each home of condominiums and single-family homes, acquiring communication information comprising data such as electric energy, gas quantity, water service consumption, fire detection, and monitored data related to energy saving of electric equipment or the like acquired from each home, and making collection and management of such communication information. In the case of a high-rise condominium, it is possible to forward communication information from terminals or terminals serving as a router installed at the top story via routers or terminals serving as a router installed at lower stories in turn to an access point AP located at the ground floor or in some other place and further collect such information to a higher-order server system. Thereby, with regard to each home of the high-rise condominium, it is possible to seek to improve a variety of tasks and improve customer services, not only a simple meter reading task, by making good use of collected data. The communication environment of each router or each terminal also serving as a router which operates intermittently differs depending on the overall structure of the high-rise condominium, the positions in which the terminals also serving as a router for each customer are installed, whether or not these terminals or routers are provided with a power feeding means, etc. According to the present embodiment, each router or each terminal also serving as a router sets or changes its intermittent operation interval based on its communication environment and information in the table. Thus, it is possible to reduce a total of power consumption across the multi-hop wireless communication system and long-term operation of the system becomes feasible.

Even for an in-house wireless network, each router or each terminal also serving as a router operating intermittently may expediently set or change its intermittent operation interval based on communication environment such as the amount of its battery consumption, the position where it is installed in the house, and whether or not it is provided with a power feeding means. Thereby, it is possible to reduce a total of power consumption across the multi-hop wireless communication system and long-term operation of the system becomes feasible.

### LIST OF REFERENCE SIGNS

100 Terminal
Router
Access point
200 Activation notice
201 Wait for reception
202 Wait for activation of a router
203 Communication information generated
204 Requirement for communication
205 Wait for requirement for communication
206 Communication information transmission
207 Communication information reception
101, 301 Transceiver
102, 302 Control device
103, 303 Built-in battery
104 Sensor interface (I/F)
105 Sensor
106, 305 Antenna
107, 304 Battery sensor
110 Terminal with the function of a router (Terminal also serving as a router)
306 Power feeding device
307 Power feeding device interface (I/F)

1. A wireless communication system for multi-hop communication through an ad-hoc network, the wireless communication system including a plurality of wireless routers and at least one terminal,
wherein the each wireless router includes a battery, a detection means for detecting the battery state, a table providing information on its own intermittent operation interval of the wireless router, and a control device that controls communication,
wherein the intermittent operation interval in the table is set so that, based on communication environment of the wireless router, including the station's battery state, the intermittent operation interval should be set shorter for a wireless router having a better communication environment, and
wherein the each wireless router sets or changes its intermittent operation interval, based on its communication environment and information in the table, and forwards communication information from the terminal during the intermittent operation.

2. The wireless communication system according to claim 1, wherein the intermittent operation interval in the table is set so that the intermittent operation interval becomes longer in response to a decrease in the remaining amount of the battery of the each wireless router.

3. The wireless communication system according to claim 2,
wherein the communication environment of the each wireless router includes easiness to replace the battery depending on the installation environment of the wireless router, and
wherein the intermittent operation interval in the table is set so that the intermittent operation interval should be set shorter for a wireless router whose battery is easier to replace.

4. The wireless communication system according to claim 2,
wherein the communication environment of the each wireless router includes whether or not the wireless router is provided with a power feeding means thereto, and
wherein the intermittent operation interval in the table is set so that the intermittent operation interval should be set shorter for a wireless router provided with the power feeding means than for a wireless router not provided with the power feeding means.

5. The wireless communication system according to claim 1,
wherein intermittent activation of the each wireless router is asynchronous, and
wherein an active period during which the each wireless router is active is set shorter than the intermittent operation interval.

6. The wireless communication system according to claim 2, wherein the each wireless router broadcasts a battery replacement alert continuously, if the remaining amount of its battery upon the intermittent activation has dropped than a definite value.

7. The wireless communication system according to claim 2, wherein the each wireless router becomes active intermittently after each end of the intermittent operation interval, sets again its intermittent operation interval depending on the remaining amount of its battery upon the intermittent activation, and then broadcasts an activation notice.

8. The wireless communication system according to claim 2,
wherein the each wireless router is provided with a timer,
wherein, when a value measured by the timer becomes equal to the intermittent operation interval, the wireless router goes into an intermittent active state,
wherein the wireless router once having become active intermittently, if the remaining amount of its battery upon the intermittent activation is less than a predetermined value, broadcasts a battery replacement alert continuously,
wherein, if the remaining amount of the battery is more than or equal to a predetermined value, the wireless router sets again its intermittent operation interval depending on the remaining amount of the battery and then broadcasts an activation notice, and
wherein the terminal, when having information to transmit, waits for the activation notice and transmits the communication information to the router that transmitted the activation notice to the terminal.

9. The wireless communication system according to claim 1,
wherein the each wireless router retains routing information, and
wherein, in forwarding information between the wireless routers, based on routing information that the each router has, a wireless router that is going to forward information responds to only activation information from a wireless router existing in a route approaching an access point that is the destination of the communication information.

10. The wireless communication system according to claim 1,
wherein at least one of the plurality of wireless routers is a terminal also serving as a router, which has the terminal function in addition to the wireless router function, and
wherein the terminal also serving as a router transmits the communication information intermittently as the terminal.

11. The wireless communication system according to claim 10,
wherein the terminal also serving as a router is provided with a sensor, and
wherein the control device intermittently transmits information acquired by the sensor as the communication information.

12. A wireless router configured in a multi-hop wireless communication system through an ad-hoc network,
the wireless communication system including a plurality of wireless routers and at least one terminal,
the wireless router having a battery, a detection means for detecting its battery state, a table providing information on its own intermittent operation interval of the wireless router, and a control device that controls communication,
wherein the intermittent operation interval in the table is set so that, depending on communication environment of the wireless router, including the station's battery state, the intermittent operation interval should be set shorter for a wireless router having a better communication environment, and
wherein the wireless router sets or changes its intermittent operation interval, based on its communication environment and information in the table.

13. The wireless router according to claim 12,
wherein the communication environment of the wireless router includes easiness to replace the battery depending on the installation environment of the wireless router, and
wherein the intermittent operation interval in the table is set so that the intermittent operation interval should be set shorter for a wireless router whose battery is easier to replace.

14. The wireless router according to claim 12,
wherein the communication environment of the wireless router includes whether or not the wireless router is provided with a power feeding means thereto, and
wherein the intermittent operation interval in the table is set so that the intermittent operation interval should be set shorter for a wireless router provided with the power feeding means than for a wireless router not provided with the power feeding means.

15. The wireless router according to claim 12,
wherein the wireless router is a terminal also serving as a router, which has the terminal function in addition to the wireless router function, and
wherein the terminal also serving as a router transmits communication information intermittently as the terminal.
